(19) United States
(12) Patent Application Publication
(10) Pub. No.: US 2022/0138569 A1
(43) Pub. Date: May 5, 2022

(54) LEARNING APPARATUS, METHOD, AND STORAGE MEDIUM

(71) Applicant: KABUSHIKI KAISHA TOSHIBA, Tokyo (JP)

(72) Inventors: Shuhei Nitta, Tokyo (JP); Atsushi Yaguchi, Tokyo (JP); Yukinobu Sakata, Kawasaki Kanagawa (JP); Akiyuki Tanizawa, Kawasaki Kanagawa (JP)

(73) Assignee: KABUSHIKI KAISHA TOSHIBA, Tokyo (JP)

(21) Appl. No.: 17/463,196

(22) Filed: Aug. 31, 2021

(30) Foreign Application Priority Data
Oct. 30, 2020 (JP) 2020-181966

(51) Int. Cl. G06N 3/08; G06N 3/04; G06K 9/62

(52) U.S. Cl. CPC G06N 3/08; G06N 3/0454; G06K 9/628; G06K 9/6268; G06K 9/6262

(57) ABSTRACT

According to one embodiment, a learning apparatus includes a processing circuit. The processing circuit acquires first sequence data representing transition of inference performance according to a training progress of a first model trained in accordance with a first training parameter value concerning a specific training condition. The processing circuit performs iterative learning of a second model in accordance with a second training parameter value concerning the specific training condition and changes the second training parameter value based on the inference performance of the second model and the first sequence data in a training process of the second model.

### CROSS-REFERENCE TO RELATED APPLICATIONS

This application is based upon and claims the benefit of priority from Japanese Patent Application No. 2020-181966, filed Oct. 30, 2020, the entire contents of which are incorporated herein by reference.

### FIELD

Embodiments described herein relate generally to a learning apparatus, a method, and a storage medium.

### BACKGROUND

There is a technique of displaying a graph showing a change in model performance such as a calculation amount or an error for each network architecture or each training parameter value such as a hyper parameter value and selecting a training condition by referring to the graph. However, it is necessary to comprehensively train a model for each of a plurality of training parameter values. A long time is needed for the training of the model, and processing is cumbersome.

### BRIEF DESCRIPTION OF THE DRAWINGS

FIG. 1 is a block diagram showing the functional configuration of a learning apparatus according to the embodiment;

FIG. 2 is a view showing an example of the architecture of a target model (slimmable neural network) according to the embodiment;

FIG. 3 is a flowchart showing the operation of the learning apparatus shown in FIG. 1;

FIG. 4 is a graph showing an example of a reference sequence curve corresponding to reference sequence data;

FIG. 5 is a graph showing a reference sequence curve corresponding to reference sequence data, a target sequence curve corresponding to target sequence data, and a predicted sequence curve corresponding to predicted sequence data;

FIG. 6 is a graph showing an example of a progress error;

FIG. 7 is a graph showing another example of the progress error;

FIG. 8 is a graph showing a display example of a target sequence curve, a predicted sequence curve, a reference sequence curve, a progress error curve, an balancing parameter value curve, and an allowable value;

FIG. 9 is a view showing an example of a display window configured to display a reject button for maintaining a current value and an adopt button for adopting a candidate value;

FIG. 10 is a graph showing a display example of a band of the predicted sequence curve; and

FIG. 11 is a block diagram showing an example of the hardware configuration of the learning apparatus according to the embodiment.

### DETAILED DESCRIPTION

In general, according to one embodiment, a learning apparatus includes a processing circuit. The processing circuit acquires first sequence data representing transition of inference performance according to a training progress of a first machine learning model trained in accordance with a first training parameter value concerning a specific training condition. The processing circuit performs iterative learning of a second machine learning model in accordance with a second training parameter value concerning the specific training condition and changes the second training parameter value based on the inference performance of the second machine learning model and the first sequence data in a training process of the second machine learning model.

A learning apparatus, method, and storage media according to this embodiment will now be described with reference to the accompanying drawings.

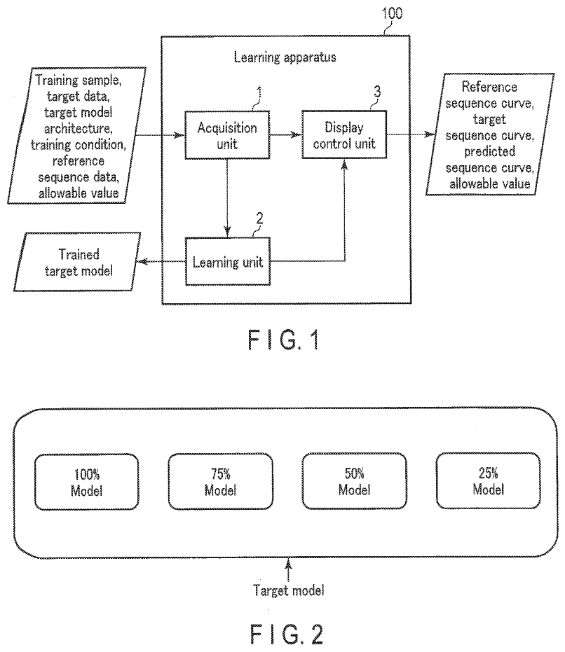

FIG. 1 is a block diagram showing the functional configuration of the learning apparatus according to this embodiment. A learning apparatus 100 shown in FIG. 1 is a computer configured to generate a trained target by training a machine learning model. The machine learning model according to this embodiment is assumed to be a neural network.

As shown in FIG. 1, the learning apparatus 100 includes an acquisition unit 1, a learning unit 2, and a display control unit 3.

The acquisition unit 1 acquires a training sample, target data, a target model architecture, a training condition, reference sequence data, and an allowable value. The acquisition unit 1 outputs the training sample, the target data, the training condition, the reference sequence data, and the allowable value to the learning unit 2, and outputs at least the reference sequence data and the allowable value to the display control unit 3.

The training sample is data input to a machine learning model for iterative learning. The training sample is associated with the target data. The combination of the training sample and the target data is called a training data set. Hereinafter, for example, the training sample is represented by xᵢ (i =1, N), and the target data is represented by ti (i=1, N). Here, i is the index of the training data set, and N indicates the total number of training data sets.

The target model architecture is the model architecture of a machine learning model (to be referred to as a target model hereinafter) that is the training target of the learning apparatus 100. The target model architecture is defined by, for example, architecture parameters such as the type of the model architecture, the number of layers of a neural network, the number of nodes of each layer, the connection method between the layers, and the type of an activation function to be used in each layer.

The training condition is a condition concerning training of the machine learning model. A parameter constituting the training condition is called a training parameter, and the value of the training parameter is called a training parameter value. Note that the training parameter is also called a hyper parameter. The training condition includes, for example, an optimization parameter, a loss function, and the like. The optimization parameter includes, for example, the type of an optimization method (optimizer), a learning rate, the number of mini batches (mini batch size), the upper limit value of an iterative learning count, an end condition, and the like. The loss function is a function for evaluating a learning cost. A parameter included in the loss function and configured to adjust the balance of a penalty to the learning cost is called a balancing parameter. The loss function according to this embodiment is a concept including an objective function obtained by adding terms such as a regularization term, a penalty term, and/or an inertia term to the learning cost.

The reference sequence data is sequence data representing the transition of inference performance according to the training progress of a machine learning model (to be referred to as a reference model hereinafter) in which at least one of the model architecture and the training condition is different from the target model. The inference performance is an index for evaluating the accuracy of inference or output of the machine learning model. The reference sequence data is referred to when changing the training parameter value in the training process of the target model.

The allowable value is used as a criterion for judging whether to change the training parameter value of the target model in the training process. The allowable value is decided based on, for example, the reference sequence data.

The learning unit 2 receives the training sample, the target data, the training condition, the reference sequence data, and the allowable value from the acquisition unit 1. The learning unit 2 iteratively trains the target model based on the training sample, the target data, and the training condition. More specifically, the learning unit 2 interactively trains the target model in accordance with a training parameter value concerning a specific training condition. The learning unit 2 outputs the training progress of iterative learning and the inference performance of the target model to the display control unit 3, and outputs the target model for which iterative learning is completed as a trained target model. In the training process of the target model, the learning unit 2 changes the training parameter value based on the inference performance of the target model and the reference sequence data. More specifically, the learning unit 2 changes the training parameter value in accordance with the difference (deviation) between inference performance indicated by the reference sequence data in a predetermined training stage and the inference performance of the target model. At this time, the learning unit 2 may change the training parameter value based on comparison between the difference and the allowable value.

The training progress is defined by the number of times of updating, for example, a trainable parameter such as a weight parameter or a bias (iterative learning count). An iteration count that is counted for every iterative learning of training sample count/mini batch size is also called an epoch number. The learning cost represents an error between output data output by inputting a training sample to a machine learning model and target data associated with the training sample. Since the learning cost represents the accuracy of inference or output of the machine learning model, it can be said that the learning cost is an example of inference performance.

The display control unit 3 receives at least the reference sequence data and the allowable value from the acquisition unit 1, and receives the training progress and the learning cost of the target model from the learning unit 2. The display control unit 3 outputs various kinds of information to a display or the like. For example, the display control unit 3 displays, as display information, a curve (to be referred to as a reference sequence curve hereinafter) corresponding to the reference sequence data, a curve (to be referred to as a target sequence curve hereinafter) corresponding to sequence data (to be referred to as target sequence data hereinafter) representing the transition of inference performance according to the training progress of the target model from the training start stage to the current point of time, a curve (to be referred to as a predicted sequence curve hereinafter) corresponding to sequence data (to be referred to as predicted sequence data hereinafter) representing prediction of the transition of inference performance according to the training progress of the target model from the current point of time to the training end stage, the allowable value, and the like.

Note that the learning apparatus 100 may include a memory and a processor. The memory stores, for example, various kinds of programs (for example, a training program for machine learning by the learning unit 2) concerning the operation of the learning apparatus 100. The processor implements the functions of the acquisition unit 1, the learning unit 2, and the display control unit 3 by executing various kinds of programs stored in the memory.

The operation of the learning apparatus 100 will be described next.

In the following description, the training sample is an image, and each of the target model and the reference model is a neural network configured to execute an image classification task for classifying an image in accordance with a target drawn in an image. The image classification task according to the following embodiment is assumed to be 2-class image classification for classifying an image to one of “dog” and “cat” as an example. The input image xi that is the training sample is a pixel set with a horizontal width W, a vertical width H, and a channel count C, and can be expressed as a (W×H×C)-dimensional vector. The label ti that is the target data is a vector having dimensions as many as the classes. In this embodiment, the label ti is a two-dimensional vector including an element corresponding to class “dog” and an element corresponding to class “cat”. Each elements takes “1” if a target corresponding to the element is drawn, and takes “0” if a target other than that is drawn. For example, if “dog” is drawn in the input image xᵢ, the label ti is represented by (1, 0)^{T}.

The model architecture of the target model is assumed to be a slimmable neural network as an example.

FIG. 2 is a view showing an example of the architecture of the target model (slimmable neural network) according to the embodiment. As shown in FIG. 2, the target model according to this embodiment can be switched to a plurality of model architectures corresponding to a plurality of calculation costs. The plurality of model architectures undergo iterative learning so as to process the same task. The calculation cost is a performance index concerning the calculation load of each model architecture, and is evaluated based on, for example, the number of hidden layers, the number of channels of each hidden layer, the resolution of the input image, and the like. The calculation cost switchable in the slimmable neural network is the number of channels of each hidden layer.

As shown in FIG. 2, the target model has a 100% model, a 75% model, a 50% model, and a 25% model as a plurality of model architectures corresponding to a plurality of model sizes. The 100% model is a model architecture that uses all channels of each hidden layer. The 100% model is the same model architecture as the reference model. The 75% model is a model architecture that uses only 75% of the channels of each hidden layer in the 100% model, the 50% model is a model architecture that uses only 50% of the channels, and the 25% model is a model architecture that uses only 25% of the channels. The target model undergoes iterative learning such that inference is possible in any of the four types of model architectures described above.

An output y₁(j) of the target model is defined by equation (1) below. Note that j is an index representing the model architecture included in the target model. In this embodiment, j={1, 2, 3, 4}, j=1 represents the 100% model, j=2 represents the 75% model, j=3 represents the 50% model, and j=4 represents the 25% model. Θ represents a set of trainable parameters such as a weight parameter and a bias. f is the function of the neural network for holding the parameter set Θ. The function f sequentially makes the input image xᵢ, propagate to hidden layers such as a convolutional layer, a fully connected layer, a normalization layer, and a pooling layer, and outputs the output label yᵢ(j) that is a two-dimensional vector. Note that the hidden layers of the target model are not limited to the above-described layers, and may include a layer for performing any processing.

yᵢ(j)=f(Θ, xᵢ, j) (1)

A loss function Lᵢ of the target model is designed as the weighted average of the learning cost Lᵢ(j) of the four types of model architectures of the target model, as indicated by equation (2) below. “i” is the index of the training sample. The learning cost Lᵢ(j) in equation (2) is expressed as a cross entropy by equation (3) below.

Lᵢ=a Lᵢ(1)+(1−a){Lᵢ(2)+Lᵢ(3)+Lᵢ(4)} (2)

Lᵢ(j)=−tᵢ^{T}1n {yᵢ(j)} (3)

“a” in equation (2) is a balancing parameter. The balancing parameter value a takes a value from 0 to 1. The balancing parameter value a is a parameter used to adjust the balance between a penalty to a learning cost Lᵢ(1) of the 100% model and a penalty to a learning cost {Lᵢ(2)+Lᵢ(3)+Lᵢ(4)} of the remaining 75%, 50%, and 25% models. The larger (closer to 1) the balancing parameter value a is made, the higher the inference performance of the 100% model becomes, and the lower the inference performance of the 75%, 50%, and 25% models becomes. The inference performance of the 100% model and the inference performance of the remaining 75%, 50%, and 25% models have a tradeoff relationship. That is, it can be said that the balancing parameter value a is a parameter used to adjust the balance between the inference performance of the 100% model and the inference performance of the remaining models. In this embodiment, the balancing parameter value a is changed in the training process of the target model, thereby implementing the balance desired by the user. The balancing parameter value a is an example of a training parameter. Note that in this embodiment, since the target model performs an image classification task, the inference performance is a recognition ratio (correct answer ratio).

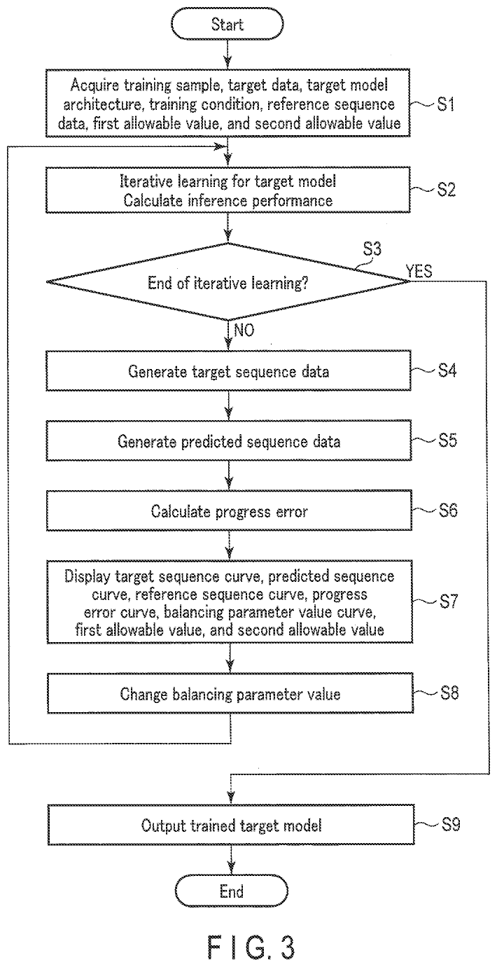

FIG. 3 is a flowchart showing the operation of the learning apparatus 100 shown in FIG. 1. Processing of the flowchart shown in FIG. 3 is started when the training program is executed by the user.

When the training program is executed, the acquisition unit 1 acquires a training sample, target data, a target model, a training condition, reference sequence data, a first allowable value, and a second allowable value (step S1). As described above, the training sample is an image, and the target data is a target label. Initial values of a weight parameter and a bias are assigned to the target model. The training condition includes various kinds of training parameters described above, and an arbitrary training parameter value is set for each training parameter. An initial value is assigned to a balancing parameter of the training parameters. The initial value of the balancing parameter can be set to an arbitrary numerical value. The first allowable value is an allowable value to be compared with target sequence data, reference sequence data, and predicted sequence data. The second allowable value is an allowable value to be compared with progress error sequence data to be described later.

In this embodiment, the same model architecture as the 100% model is used as the reference model. That is, the reference model is a slimmable neural network that has undergone iterative learning in accordance with the balancing parameter value a=1 as a basic training condition. In this case, the reference sequence data is sequence data r(e) representing the transition of a learning cost according to the training progress of the reference model (100% model). Here, e={1, 2, . . . , E}. e is the epoch number, and E is the total number of epoch numbers.

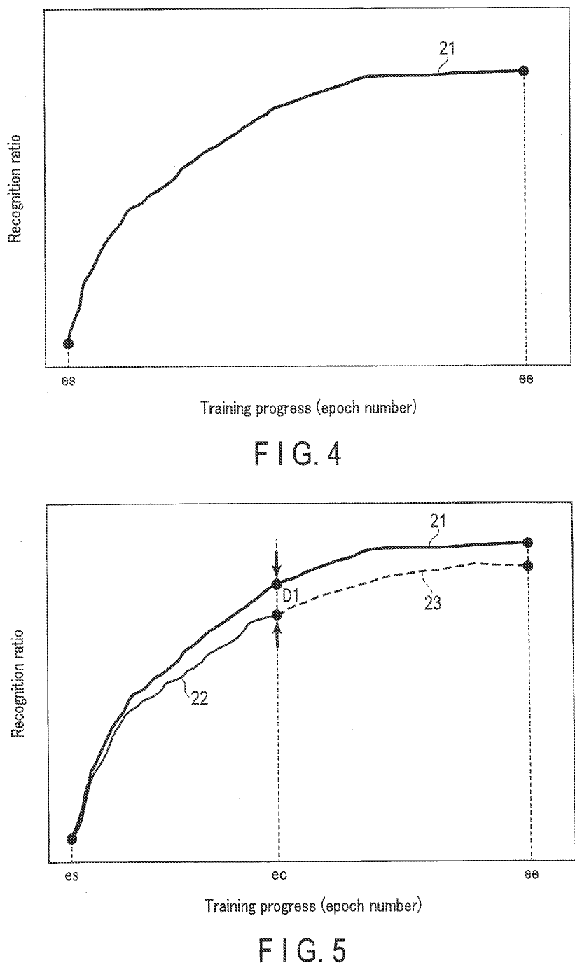

FIG. 4 is a graph showing an example of a reference sequence curve 21 corresponding to reference sequence data. As shown in FIG. 4, the reference sequence curve 21 is expressed by the graph whose ordinate is defined by the recognition ratio, and whose abscissa is defined by the training progress (epoch number). As shown in FIG. 4, in the training process of the reference model, the recognition ratio improves as the training progresses.

A first allowable value R1 in this embodiment in which a slimmable neural network is used is set based on the recognition ratio of the 100% model. The slimmable neural network is trained based on a concept that, for example, the recognition ratio of the 100% model is equal to or more than the first allowable value R1 (%), and the recognition ratios of the 75% model, the 50% model, and the 25% model should be as high as possible. In the training of the target model according to this embodiment, since the balance of the recognition ratios of the models of the target model is adjusted using the balancing parameter value a, training is performed using the balancing parameter value a that is as small as possible within the range in which the recognition ratio of the 100% model is equal to or more than the first allowable value R1 (%).

When step S1 is performed, the learning unit 2 executes iterative learning for the target model acquired in step S1 (step S2). In step S2, using, for example, a learning cost based on the average of learning costs of a training sample set selected in accordance with a mini batch size, the learning unit 2 iteratively learns the value of the parameter set Θ of the target model by backpropagation and stochastic gradient descent. More specifically, for a plurality of combinations of the training sample and target data, the learning unit 2 searches for the parameter set Θ that minimizes (or maximizes) the loss function Lᵢ based on the balancing parameter value and the learning cost Lᵢ(j) of each model. The learning cost Lᵢ(j) is calculated in accordance with equation (3) based on a teaching label and an output label calculated by performing a forward propagation operation of the target model based on the training sample. The found parameter set Θ is assigned to the target model.

In step S2, the learning unit 2 applies a validation sample to the target model to which the found parameter set Θ is assigned, thereby calculating a recognition ratio as inference performance. As the recognition ratio, for example, a validation accuracy is calculated. Note that the learning unit 2 may apply a training sample to the target model to which the found parameter set Θ is assigned, thereby calculating a training accuracy as the recognition ratio. These recognition ratios are converted from a learning cost calculated based on the validation sample or a learning cost calculated based on the training sample. The recognition ratio is stored in a memory or the like in association with an epoch number representing a current progress stage.

When step S2 is performed, the learning unit 2 determines whether to end the iterative learning (step S3). In step S3, the learning unit 2 determines, based on an end condition, whether to end the iterative learning. For example, the learning unit 2 determines whether an end condition based on the target sequence data and the first allowable value R1 is satisfied. The end condition is defined as a condition that, for example, the recognition ratio represented by the target sequence data reaches the first allowable value R1. Note that the end condition is not limited to this and may be defined as a condition that, for example, the current epoch number reaches the total epoch number.

Upon determining not to end the iterative learning in step S3 (NO in step S3), the learning unit 2 generates target sequence data (step S4). In step S4, the learning unit 2 generates target sequence data representing the transition of the recognition ratio from the training start stage to the current epoch number (current progress stage). More specifically, target sequence data is generated as data that associates the recognition ratio calculated in step S2 and the epoch number associated with the recognition ratio.

When step S4 is performed, the learning unit 2 generates predicted sequence data (step S5). In step S5, the learning unit 2 generates predicted sequence data based on the target sequence data generated in step S4.

FIG. 5 is a graph showing the reference sequence curve 21 corresponding to reference sequence data, a target sequence curve 22 corresponding to the target sequence data, and a predicted sequence curve 23 corresponding to the predicted sequence data. As shown in FIG. 5, the target sequence curve 22 represents the transition of the recognition ratio of the target model from a training start stage es to a current epoch number ec. The predicted sequence curve 23 represents the transition of prediction of the recognition ratio of the target model from the current epoch number ec to a training end stage ee. The reference sequence curve 21 represents the transition of the recognition ratio of the reference model from the training start stage es to the training end stage ee.

A predicted sequence data generation method will be described. In step S5, the learning unit 2 generates predicted sequence data based on the target sequence data and the reference sequence data. For example, the learning unit 2 generates predicted sequence data based on an assumption that the difference between the target sequence data and the reference sequence data is maintained.

More specifically, the learning unit 2 calculates the difference between the recognition ratio represented by the target sequence data and the recognition ratio represented by the reference sequence data at a predetermined training stage. The predetermined training stage can be set to an arbitrary epoch number. For example, as shown in FIG. 5, the learning unit 2 calculates a difference D1 between the recognition ratio represented by the target sequence data and the recognition ratio represented by the reference sequence data at the current epoch number ec. Next, based on an assumption that the calculated difference D1 is maintained from the current epoch number ec to the training end stage ee, the learning unit 2 generates predicted sequence data by multiplying the reference sequence data from the current epoch number ec to the training end stage ee by the ratio of the difference Dl. For example, the ratio of the difference D1 is calculated as the ratio of the difference D1 to the recognition ratio represented by the reference sequence data. At this time, the learning unit 2 may calculate, as the recognition ratio of the predicted sequence data for the epoch number, the multiplication value of the ratio corresponding to the recognition ratio represented by the reference sequence data for each epoch number from the current epoch number ec to the training end stage ee, or may calculate, as the recognition ratio of the predicted sequence data for the epoch number, the multiplication value of the ratio corresponding to the moving average value of the recognition ratio concerning the epoch number.

Note that the ratio calculation method is not limited to the above-described method. For example, the learning unit 2 calculates the average value of ratios during the period from the current epoch number ec to the epoch number before a predetermined number of times or the average value of ratios during the whole period from the training start stage es to the current epoch number ec. The learning unit 2 may generates the predicted sequence data by multiplying the reference sequence data by the calculated average value.

As another generation method of predicted sequence data, the learning unit 2 may generate predicted sequence data by applying target sequence data to a table generated from experimental results in the past. Also, the learning unit 2 may generate predicted sequence data by applying target sequence data to a machine learning model that has learned a weight parameter such that sequence data representing the transition of the recognition ratio from the training start stage to an arbitrary halfway stage is input, and sequence data representing the transition of the recognition ratio from the halfway stage to the training end stage is output.

When step S5 is performed, the learning unit 2 calculates the progress error (step S6). In step S6, the learning unit 2 calculates, as the progress error, the difference between the recognition ratio represented by target sequence data or predicted sequence data and the recognition ratio represented by reference sequence data at a predetermined training stage.

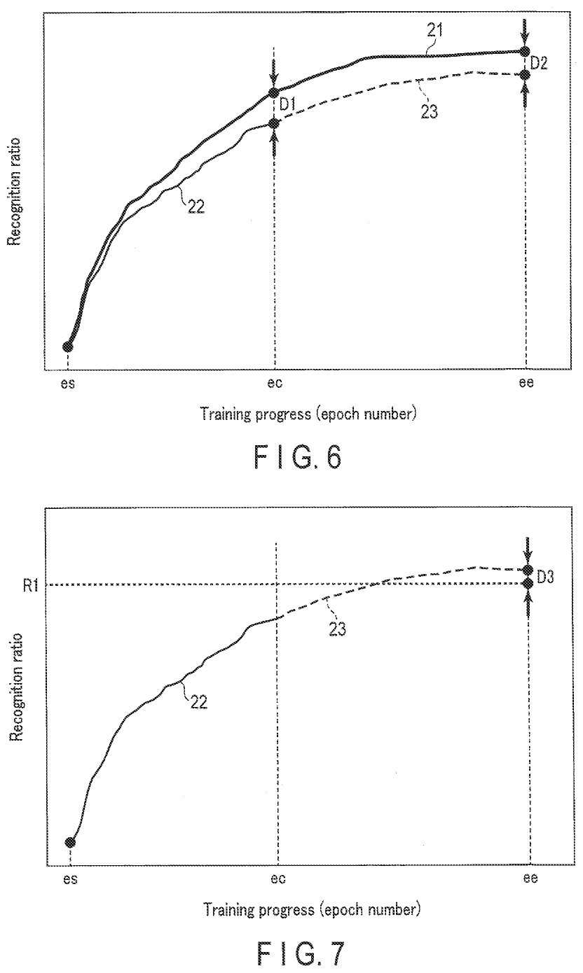

FIG. 6 is a graph showing an example of the progress error. FIG. 6 shows the differences D1 and D2 on the reference sequence curve 21, the target sequence curve 22, and the predicted sequence curve 23, which are the same as in FIG. 5. As shown in FIG. 6, for example, the learning unit 2 calculates, as the progress error, the difference D1 between the recognition ratio represented by the target sequence curve 22 and the recognition ratio represented by the reference sequence curve 21 at the current epoch number ec. As another example, the learning unit 2 may calculate, as the progress error, the difference D2 between the recognition ratio represented by the predicted sequence curve 23 and the recognition ratio represented by the reference sequence curve 21 at the training end stage ee. Note that the learning unit 2 may calculate, as the progress error, the difference between the recognition ratio represented by the target sequence curve 22 or the predicted sequence curve 23 and the recognition ratio represented by the reference sequence curve 21 at an arbitrary stage other than the current epoch number ec and the training end stage ee.

In step S6, the learning unit 2 may calculate the difference between the target sequence curve 22 itself and the reference sequence curve 21 itself as the progress error. As the difference between the target sequence curve 22 itself and the reference sequence curve 21 itself, for example, the difference between the target sequence curve 22 and the reference sequence curve 21 at the training end stage ee is used. As another example, the difference between a recognition ratio represented by the representative point of the target sequence curve 22 and a recognition ratio represented by the representative point of the reference sequence curve 21 may be used. The representative point is set to the gravity center point, the average point, or the like of the target sequence curve 22 or the reference sequence curve 21. Also, a statistic value such as the average value of the differences between the recognition ratio of the target sequence curve 22 and the recognition ratio of the reference sequence curve 21 at the epoch numbers may be calculated as the progress error. Similarly, the learning unit 2 may calculate the difference between the predicted sequence curve 23 itself and the reference sequence curve 21 itself as the progress error.

Note that the reference sequence curve 21, the target sequence curve 22, and the predicted sequence curve 23 are merely forms of the reference sequence data, the target sequence data, and the predicted sequence data, respectively, and the progress error may be calculated based on numerical data that is sequence data, or the progress error may be calculated based on curves, as described above.

As another example, the learning unit 2 may calculate the difference between the first allowable value R1 and the recognition ratio represented by the predicted sequence data as the progress error.

FIG. 7 is a graph showing an example of the difference (progress error) between the first allowable value R1 and the recognition ratio represented by the predicted sequence data. FIG. 7 shows the progress error on the target sequence curve 22 and the predicted sequence curve 23, which are the same as in FIG. 5. As shown in FIG. 7, the learning unit 2 calculates, as the progress error, for example, a difference D3 obtained by subtracting the recognition ratio (to be referred to as a final predicted recognition ratio hereinafter) represented by the predicted sequence curve 23 at the training end stage ee from the first allowable value R1. If the final predicted recognition ratio is higher than the first allowable value R1, the difference D3 is a negative value. If the final predicted recognition ratio is lower than the first allowable value R1, the difference D3 is a positive value.

The learning unit 2 may calculate, as the progress error, the difference between the first allowable value R1 and the recognition ratio represented by the predicted sequence curve 23 at an arbitrary stage other than the training end stage ee. Also, the learning unit 2 may calculate the difference between the first allowable value R1 and the whole predicted sequence curve 23 as the progress error. As the difference between the first allowable value R1 and the whole predicted sequence curve 23, for example, the difference between a recognition ratio represented by the representative point of the predicted sequence curve 23 and a recognition ratio represented by the first allowable value R1 may be used. The representative point is set to the gravity center point, the average point, or the like of the predicted sequence curve 23. Also, a statistic value such as the average value of the differences between the first allowable value R1 and the recognition ratio represented by the predicted sequence curve 23 at the epoch numbers may be calculated as the progress error.

A curve corresponding to the sequence data (to be referred to as progress error sequence data hereinafter) formed by a progress error calculated at each position of the training progress will be referred to as a progress error curve hereinafter. In addition, progress error sequence data based on target sequence data and reference sequence data will be called result progress error sequence data, and progress error sequence data based on predicted sequence data and reference sequence data will be called predicted progress error sequence data. Also, a curve corresponding to the result progress error sequence data is called a result progress error curve, and a curve corresponding to the predicted progress error sequence data is called a predicted progress error curve. Note that if the result progress error sequence data and the predicted progress error sequence data are not particularly discriminated, they are called progress error sequence data, and if the result progress error curve and the predicted progress error curve are not particularly discriminated, they are called progress error sequence curves. Additionally, in the following description, as an example, the progress error is a difference obtained by subtracting the final predicted recognition ratio from the first allowable value R1.

When step S6 is performed, the display control unit 3 displays the target sequence curve, the predicted sequence curve, the reference sequence curve, the progress error curve, the balancing parameter value curve, the first allowable value and/or the second allowable value (step S7). In step S7, the display control unit 3 displays, on a display, for example, the target sequence curve, the predicted sequence curve, the reference sequence curve, the progress error curve, the balancing parameter value curve, and the allowable values.

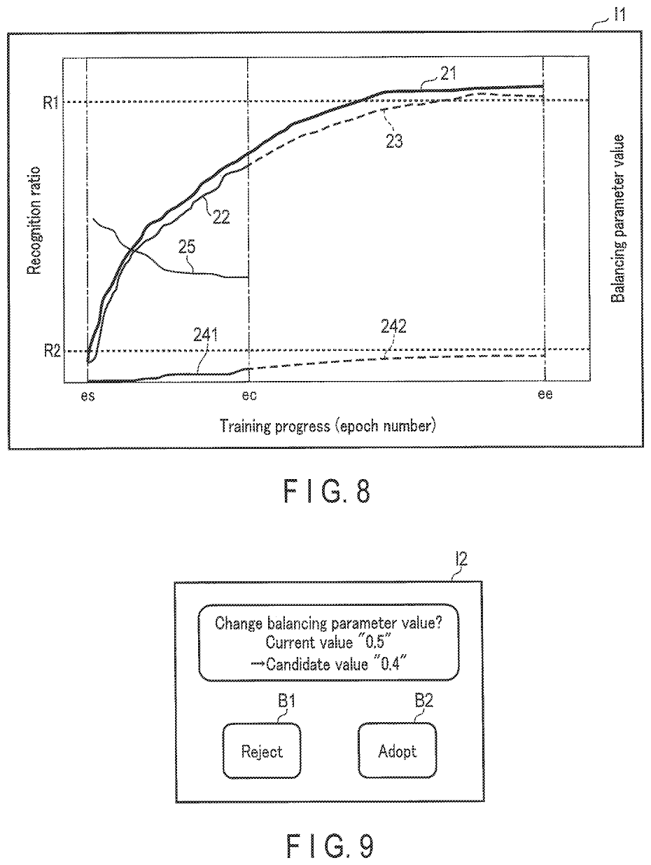

FIG. 8 is a graph showing a display example of the target sequence curve 22, the predicted sequence curve 23, the reference sequence curve 21, a result progress error curve 241, a predicted progress error curve 242, a balancing parameter value curve 25, the first allowable value R1, and a second allowable value R2. The target sequence curve 22, the predicted sequence curve 23, the reference sequence curve 21, the result progress error curve 241, the predicted progress error curve 242, the first allowable value R1, and the second allowable value R2 are graphs whose ordinate is whose ordinate is defined by the recognition ratio, and whose abscissa is defined by the training progress (epoch number). The balancing parameter value curve 25 is a graph whose ordinate is whose ordinate is defined by the balancing parameter value, and whose abscissa is defined by the training progress (epoch number).

The target sequence curve 22 is a curve corresponding to the target sequence data generated in step S4. The predicted sequence curve 23 is a curve corresponding to the predicted sequence data generated in step S5. The reference sequence curve 21 is a curve corresponding to the reference sequence data generated in step S1. The result progress error curve 241 is a curve corresponding to the result progress error sequence data based on the target sequence data and the reference sequence data, which is calculated in step S6, and the predicted progress error curve 242 is a curve corresponding to the predicted progress error sequence data based on the predicted sequence data and the reference sequence data, which is calculated in step S6. The balancing parameter value curve 25 is a curve corresponding to sequence data (to be referred to as balancing parameter value sequence data hereinafter) representing the transition of the balancing parameter value according to the training progress. The balancing parameter value is changed in step S8. The first allowable value R1 is an allowable value for the recognition ratios represented by the target sequence curve 22 and the predicted sequence curve 23. The second allowable value R2 is an allowable value for the progress errors represented by the result progress error curve 241 and the predicted progress error curve 242.

When the target sequence curve 22 and the reference sequence curve 21 are displayed side by side, the operator can visually confirm the degree of difference between the target sequence curve 22 and the reference sequence curve 21. When the predicted sequence curve 23 is displayed, the operator can predict a final recognition ratio expected for the target model in a case in which iterative learning is performed with the current balancing parameter value. When the predicted sequence curve 23 and the first allowable value R1 are displayed side by side, the operator can visually judge whether the final recognition ratio expected for the target model reaches the first allowable value R1. When the predicted sequence curve 23 and the reference sequence curve 21 are displayed side by side, the operator can visually confirm the degree of difference between the predicted sequence curve 23 and the reference sequence curve 21. When the result progress error curve 241, the predicted progress error curve 242, and the second allowable value R2 are displayed side by side, the operator can visually confirm whether the progress error exceeds the second allowable value R2. In addition, when the balancing parameter value curve 25 is displayed, it is possible to know the association between the transition of the balancing parameter value and the transition of the progress error or the recognition ratio of the target model, and the like.

Note that in step S7, the display control unit 3 need not always display all the target sequence curve 22, the predicted sequence curve 23, the reference sequence curve 21, the result progress error curve 241, the predicted progress error curve 242, the balancing parameter value curve 25, the first allowable value R1, and the second allowable value R2 on a single graph. For example, the display control unit 3 may individually display the graph of the target sequence curve 22, the predicted sequence curve 23, the reference sequence curve 21, the result progress error curve 241, the predicted progress error curve 242, the first allowable value R1, and the second allowable value R2 and the graph of the balancing parameter value curve 25. Also, the display control unit 3 may individually selectively display the target sequence curve 22, the predicted sequence curve 23, the reference sequence curve 21, the result progress error curve 241, the predicted progress error curve 242, the first allowable value R1, and the second allowable value R2. For example, the display control unit 3 may selectively display the target sequence curve 22, the predicted sequence curve 23, the reference sequence curve 21, and the first allowable value R1, or may selectively display the result progress error curve 241, the predicted progress error curve 242, and the second allowable value R2.

When step S7 is performed, the learning unit 2 changes the balancing parameter value (step S8). In step S8, the learning unit 2 changes the balancing parameter value in accordance with, for example, the predicted sequence data generated in step S5. In this case, the learning unit 2 changes the balancing parameter value a in accordance with the difference (progress error) calculated in step S6 and obtained by subtracting the final predicted recognition ratio from the first allowable value R1. As described above, if the final predicted recognition ratio is higher than the first allowable value R1, the difference D3 is a negative value. If the final predicted recognition ratio is lower than the first allowable value R1, the difference D3 is a positive value.

If the progress error D3 is a positive value, the final recognition ratio of the 100% model may be lower than the first allowable value R1. Hence, the balancing parameter value is made close to the balancing parameter value of the reference model, that is, the balancing parameter value a is made large. In a case in which the progress error D3 is a negative value, as the progress error D3 becomes small, the recognition ratio of the 100% model can be expected to ensure the first allowable value R1. To make the recognition ratios of the remaining 75%, 50%, and 25% models higher, the balancing parameter value is separated from the balancing parameter value a of the reference model, that is, the balancing parameter value a is made small. To make the balancing parameter value a large, a value ε is added to the balancing parameter value a. To make the balancing parameter value a small, the value ε is subtracted from to the balancing parameter value a. The value ε may be a predetermined fixed value, or may be a variable value according to the difference between the first allowable value R1 and the recognition ratio represented by the predicted sequence data. If the value ε is a variable value, it is set such that, for example, the larger the difference between the first allowable value R1 and the recognition ratio represented by the predicted sequence data is, the larger the value E becomes, and the smaller the difference between the first allowable value R1 and the recognition ratio represented by the predicted sequence data is, the smaller the value E becomes. Also, the value E may be set to a value designated by the operator via an input device.

Here, the learning unit 2 may change the balancing parameter value based on the second allowable value R2 and the difference (progress error) between the recognition ratio represented by the predicted sequence data and the recognition ratio represented by the reference sequence data. If the progress error is larger than the second allowable value R2, the final recognition ratio of the 100% model may be lower than the recognition ratio expected by the operator. Hence, the balancing parameter value is made close to the balancing parameter value of the reference model, that is, the balancing parameter value is made large. In a case in which the progress error is smaller than the second allowable value R2, the recognition ratio of the 100% model can be expected to ensure the recognition ratio expected by the operator. Hence, to make the recognition ratios of the 75%, 50%, and 25% models higher, the balancing parameter value is separated from the balancing parameter value of the reference model, that is, the balancing parameter value is made small.

As another example, the learning unit 2 may change the balancing parameter value based on the recognition ratio represented by the predicted sequence data and the recognition ratio represented by the reference sequence data. More specifically, the learning unit 2 may change the balancing parameter value in accordance with the recognition ratio represented by the predicted sequence data and the recognition ratio represented by the reference sequence data at a predetermined progress stage such as the training end stage ee.

As still another example, if the difference between the recognition ratio represented by the target sequence data and the recognition ratio represented by the reference sequence data is calculated as the progress error, the learning unit 2 may change the balancing parameter value in accordance with the progress error, as in the above-described method. For example, the balancing parameter value is changed in accordance with the difference between the recognition ratio represented by the target sequence data and the recognition ratio represented by the reference sequence data at the current epoch number. In this case, the learning unit 2 may change the balancing parameter value based on the first allowable value R1 and the difference (progress error) between the recognition ratio represented by the target sequence data and the recognition ratio represented by the reference sequence data. Also, without generating the target sequence data, the learning unit 2 may change the balancing parameter value based the difference between the recognition ratio of the target model and the recognition ratio represented by the reference sequence data at the current epoch number. In this case, the learning unit 2 may change the balancing parameter value based on the first allowable value R1 and the difference (progress error) between the recognition ratio of the target model and the recognition ratio represented by the reference sequence data.

When step S8 is performed, the learning unit 2 performs iterative learning of the target model in accordance with the balancing parameter value after the change in step S8 (step S2). Note that the balancing parameter value may be automatically changed by the learning unit 2, or may be changed after an approval by the operator via an input device or the like is obtained. To obtain the approval, for example, the display control unit 3 displays, on a display device, a display window I1 or the like, which displays a reject button B1 used to maintain the current value and an adopt button B2 used to adopt a candidate value, as shown in FIG. 9. At this time, for the sake of reference, the display control unit 3 may display the current value of the balancing parameter and a candidate value obtained by adding or subtracting the value ε to or from the current value side by side, as shown in FIG. 9. If the reject button B1 is pressed via an input device or the like, the learning unit 2 performs iterative learning allowable value the current value of the balancing parameter (step S2). If the adopt button B2 is pressed via an input device or the like, the learning unit 2 sets the candidate value to the balancing parameter value and performs iterative learning in accordance with the balancing parameter value (step S2). In addition, the balancing parameter value may be changed to a value designated by the operator via an input device.

In this way, the learning unit 2 sequentially repeats steps S4, S5, S6, S7, S8, S2, and S3 until it is determined to end the iterative learning in step S3. Along with this repeat, the training progresses, and the target sequence data, the predicted sequence data, the progress error sequence data, and the balancing parameter value sequence data are updated. Depending on the numerical value of the balancing parameter value a, from a broader viewpoint, as the training progresses, the learning cost is reduced, and the recognition ratio improves. In step S3, if the end condition of iterative learning, for example, “target sequence data reaches the first allowable value R1” is satisfied, the learning unit 2 determines to end the iterative learning. Upon determining to end the iterative learning in step S3 (NO in step S3), the learning unit 2 outputs a trained target model (step S9). In step S9, the learning unit 2 outputs, as the trained target model, the target model to which the training target parameter at the training end stage is assigned. After step S9, the training program is ended.

As described above, according to this embodiment, in the target model training process, the balancing parameter value of the target model can dynamically be corrected by referring to the recognition ratio of the target model and the recognition ratio of the reference model trained in accordance with a known balancing parameter value. This makes it possible to efficiency generate the target model having the recognition ratio expected by the operator as compared to a case in which iterative learning is performed from the beginning for each of a plurality of balancing parameter values.

Note that various modifications can be made for the above-described embodiment without departing from the scope of the present invention. For example, modifications as follows are possible.

(Modification 1)

In the above-described embodiment, each of the first allowable value and the second allowable value is a constant value. However, each of the first allowable value and the second allowable value according to Modification 1 may be sequence data that changes in accordance with the epoch number. In this case, the first allowable value and the second allowable value are strictly set such that the progress error becomes small as the epoch number becomes large. More specifically, the values are set such that as the epoch number becomes large, the first allowable value becomes large, and the second allowable value becomes small. According to Modification 1, it is possible to appropriately adjust the balancing parameter value in accordance with the progress stage.

(Modification 2)

In the above-described embodiment, the reference model is a 100% model. However, the reference model according to Modification 2 may be set to one model architecture of the 75%, 50%, and 25% models other than the 100% model. In this case, the balancing parameter adjusts the balance between a penalty to a learning cost of one model architecture that is the reference model and penalties to learning costs of the remaining three model architectures. For example, if the reference model is set to the 25% model, the balancing parameter value can be changed by regarding the recognition ratio of the reference model as the lower limit of the recognition ratio of the target model. According to Modification 2, it is possible to flexibly adjust the inference performance of the 100% model, the 75% model, the 50% model, and the 25% model in accordance with the purpose of the operator.

(Modification 3)

In the above-described embodiment, the balancing parameter adjusts the balance between a learning cost of one model and a learning cost of another model, that is, the balance of penalties to learning costs of two types of models. However, the balancing parameter according to Modification 3 may adjust the balance of penalties to three or more types of learning costs. For example, when adjusting the balance of penalties to three types of learning costs, the loss function can be given by

Lᵢ=a Lᵢ(1)+(2/3−2a/3)Lᵢ(2)+(1/3−a/3){Lᵢ(3)+Lᵢ(4)} (4)

Note that the coefficients to multiply Lᵢ(1), Lᵢ(2), and {Lᵢ(3)+Lᵢ(4)} are merely examples and can arbitrarily be designed as long as these synchronize with the balancing parameter value a. According to Modification 3, in the training process of the target model, the penalty to the learning cost between model architectures can be adjusted in more detail, and inference performance between model architectures can be discriminated in more detail.

(Modification 4)

The learning unit 2 according to Modification 4 can perform retraining. If the difference (progress error) between the recognition ratio represented by the reference sequence data and the recognition ratio of the target model is larger than a reference error, the learning unit 2 redoes iterative learning from the training progress stage (epoch number) to which the training has gone back. If the progress error is larger than the reference error, the performance of the target model cannot be guaranteed. For this reason, it is preferable to redo iterative learning while going back from the current epoch number by a predetermined number of stages (to be referred to as a retroactive epoch number hereinafter). In the training process, the learning unit 2 stores a trainable parameter value such as a weight parameter value or a bias value for each epoch number.

After iterative learning is performed in step S2, it is determined whether the progress error is larger than the reference error. If the progress error is smaller than the reference error, retraining is not performed. If the progress error is larger than the reference error, the learning unit 2 reads out the training target parameter value at the epoch number to which the training has gone back, overwrites the readout training target parameter value on the training target parameter value at the current epoch number, and resumes iterative learning from the epoch number to which the training has gone back. At this time, the balancing parameter value may be overwritten on the balancing parameter value at the epoch number to which the training has gone back, or the balancing parameter value at the current epoch number may be diverted. The retroactive epoch number may arbitrarily be set, or may be set by the operator via an input device. The reference error is set to an arbitrary value, and can be acquired by the acquisition unit 1. According to Modification 4, since retraining is performed in a case in which the progress error is larger than the reference error, the performance of the target model can be guaranteed.

(Modification 5)

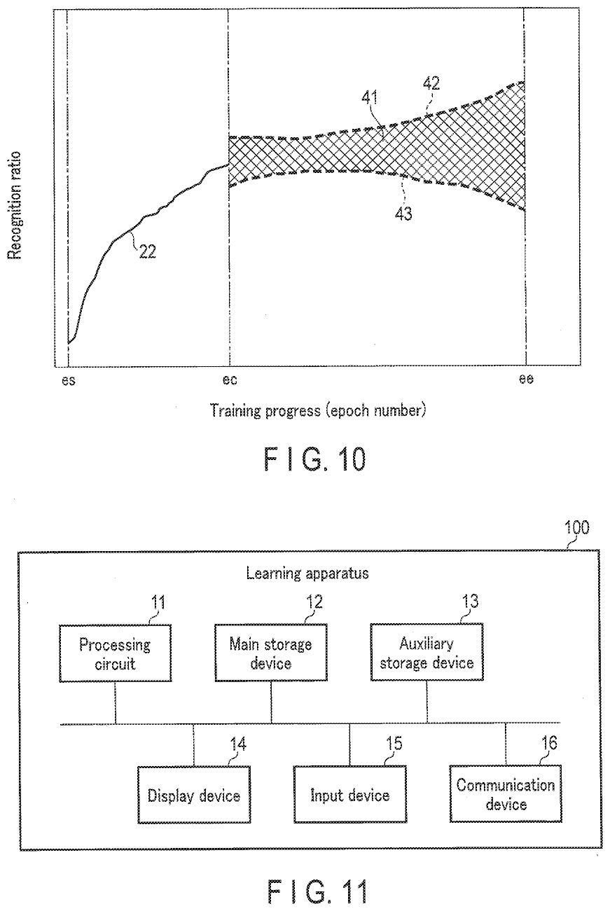

In the above-described embodiment, the predicted sequence data is uniquely decided. When predicting predicted sequence data using a machine learning model, the learning unit 2 according to Modification 5 can predict the recognition ratio at each epoch number of predicted sequence data with uncertainty. The display control unit 3 displays a predicted sequence curve corresponding to the predicted sequence data using a band 41, as shown in FIG. 10. An upper end 42 of the band corresponds to the sequence data of the upper limit value of the possible recognition ratio, and a lower end 43 of the band corresponds to the sequence data of the lower limit value of the possible recognition ratio. This means that the larger the deviation between the upper limit value and the lower limit value is, the larger the uncertainty is. The learning unit 2 adjusts the balancing parameter value based on the information of the band, that is, the information from the upper limit value to the lower limit value of the recognition ratio.

For example, the learning unit 2 calculates a first progress error based on the upper limit value at the epoch number (for example, the training end stage ee) of the progress error calculation target and a second progress error based on the lower limit calculates a third progress error based on an arbitrary recognition ratio between the upper limit value and the lower limit value, calculates an arbitrary statistic value based on the first progress error, the second progress error, and the third progress error, and changes the balancing parameter value using the statistic value as a progress error. As the statistic value, an arbitrary value such as the maximum value, the minimum value, the intermediate value, or the average value of the first progress error, the second progress error, and the third progress error can be used. Also, the statistic value may be calculated based on the first progress error, the second progress error, and the third progress error, which are weighted in accordance with uncertainty. According to Modification 5, it is possible to change the balancing parameter value in consideration of the uncertainty of predicted sequence data.

(Modification 6)

In the above-described embodiment, the target model and the reference model execute an image classification task. However, a target model and a reference model, which execute a task other than the image classification task, may be used. For example, a target model and a reference model, which execute a segmentation task or a regression task, may be used. The input to the target model and the reference model need not always be an image, and an arbitrary format such as a numerical value or a waveform may be set to the input.

(Modification 7)

In the above-described embodiment, the target model is implemented by a slimmable neural network capable of switching the number of channels as an example of a machine learning model capable of switching the calculation cost. The target model according to Modification 7 may be implemented by a plurality of machine learning models capable of switching the number of hidden layers or the resolution of an input image.

As another example, the target model may be implemented by a scalable DNN capable of changing the calculation cost by switching the rank of the weight matrix of a hidden layer. The scalable DNN has a plurality of model architectures corresponding to a plurality of calculation costs by decomposing the weight matrix and controlling the rank. Since training of the scalable DNN is performed by balancing, by a balancing parameter, the ratio between the loss function of a full rank (a model without calculation cost reduction by matrix decomposition) and the loss function of a low rank (a model that has reduced the cost reduction by matrix decomposition), the balancing parameter value can be corrected in the same manner as in the above-described embodiment.

(Modification 8)

In the above-described embodiment, the target model is implemented by a slimmable neural network capable of switching the number of channels as an example of a machine learning model capable of switching the calculation cost. In Modification 8, a case in which regularization such as weight decay is introduced, thereby reducing the model size by pruning that is a technique of removing a weight parameter with a low inference contribution degree after training will be examined. The target model and the reference model according to Modification 8 have the same architecture at the time of training, and have different strengths of regularization as a training parameter.

A loss function L according to Modification 8 is designed as the sum of the learning cost (the average of a mini batch size B) in the first term of the right side and the regularization term in the second term of the right side, as indicated by equation (6) below. A regularization term R(Θ) is defined by, for example, the sum of squares of each weight parameter. In Modification 8, since one model architecture exists, the description of J is eliminated. The balancing parameter value a according to Modification 8 is a training parameter used to adjust the balance between the learning cost and the regularization. When the balancing parameter value a is made large, the strength of regularization becomes high, and taking of a high value by the weight parameter is suppressed. As a result, weight parameters with a low inference contribution degree increase, weight parameters that can be pruned after training increase, and the model size can be reduced. On the other hand, when the balancing parameter value a is made large, the contribution of regularization in the loss function L increases, and therefore, the recognition ratio lowers relatively. When the balancing parameter value a is made small, the contribution of regularization lowers, and therefore, the recognition ratio increases relatively. As described above, tradeoff according to an increase/decrease of the balancing parameter value exists between the model size and the recognition ratio.

L=−1/BΣᵢ^{B}(tᵢ^{T}1n{f(Θ, xᵢ)})+a R(Θ) (6)

The reference model according to Modification 8 is, for example, a neural network trained based on a small value such as a balancing parameter value a=0, and the recognition ratio is high, although the model size is large. When training the target model, iterative learning is performed while adjusting the balancing parameter value a, thereby efficiently executing setting of the balancing parameter value a for making the model size as small as possible while maintaining a desired recognition ratio.

(Modification 9)

In the above-described embodiment, the target model is implemented by a slimmable neural network capable of switching the number of channels as an example of a machine learning model capable of switching the calculation cost. The target model and the reference model according to Modification 9 are neural networks having the same model architecture, which are neural networks configured to perform segmentation or image classification. In the segmentation, the pixels of an image are classified into classes. In the image classification, images are classified into classes. The balancing parameter according to Modification 9 adjusts a penalty to a learning cost concerning each class.

The loss function Lᵢ according to Modification 9 is a loss function concerning training of a segmentation or image classification model, as indicated by equation (7) below, and is designed as the sum of a learning cost LC1ᵢ concerning a first class and a learning cost LC2ᵢ concerning a second class. Each of the learning costs LC1ᵢ and LC2ᵢ is defined as a cross entropy, like equation (3). Since the target model according to Modification 9 has one model architecture, the description of j is eliminated. The balancing parameter value a according to Modification 9 is a balancing parameter used to adjust the balance between a penalty to the learning cost LC1ᵢ and a penalty to the learning cost LC2ᵢ. The balancing parameter value a according to the Modification 9 can take a value from 0 to 1.

Lᵢ=a LC1ᵢ+(1−a) LC2ᵢ (7)

The reference model according to Modification 9 is trained in accordance with the arbitrary balancing parameter value a. For example, in the reference model, a=0.7, and training with importance placed on the learning cost LC1ᵢ concerning the first class is performed. According to Modification 9, in the training process of the target model, the balancing parameter value is dynamically adjusted, thereby performing iterative learning while adjusting the balance between a penalty to the learning cost concerning the first class and a penalty to the learning cost concerning the second class. For example, if the first class is “human”, and the second class is “dog”, a penalty applied when a pixel of “human” is judged not to be “human” and a penalty applied when a pixel of “dog” is judged not to be “dog” can be adjusted. Note that if the number of classes is three or more, the class set is divided into a first class group and a second class group in accordance with an arbitrary criterion. Hence, according to Modification 9, it is possible to generate a target model having segmentation performance or classification performance desired by the operator.

(Modification 10)

The target model and the reference model according to Modification 10 are neural networks having the same model architecture, which are neural networks configured to perform object detection. In the object detection, an object detected in objects drawn in an image is surrounded by an ROI, and the object surrounded by the ROI is classified into a class. The balancing parameter according to Modification 10 adjusts a penalty to a learning cost concerning class classification or the ROI size.

For the target model and the reference model according to Modification 10, iterative learning can be performed using a loss function for evaluating a learning cost concerning a class and a loss function for evaluating a learning cost concerning an ROI position, which are calculated for each object drawn in an image.

The loss function Lᵢ according to Modification 10, which evaluate a learning cost concerning a class, can be designed as the sum of a learning cost LR1ᵢ of an object concerning a first ROI size and a learning cost LR2ᵢ of an object concerning a second ROI size, as indicated by equation (8) below. The threshold of the ROI size is set as a predetermined value in advance. The learning costs LR1ᵢ and LR2ᵢ are defined as an estimated error (cross entropy) concerning class classification of a corresponding object and an error concerning a position displacement of the ROI, respectively. Since the target model according to Modification 10 has one model architecture, the description of j is eliminated. The balancing parameter value a according to Modification 10 is a balancing parameter used to adjust the balance between a penalty to the learning cost LR1ᵢ and a penalty to the learning cost LR2ᵢ. The balancing parameter value a according to the Modification 10 can take a value from 0 to 1.

Lᵢ=a LR1ᵢ+(1−a) LR2ᵢ (8)

The reference model according to Modification 10 is trained in accordance with the arbitrary balancing parameter value a. For example, in the reference model, a=1, and training with importance placed on the learning cost concerning the first ROI size is performed. According to Modification 10, in the training process of the target model, it is possible to perform iterative learning while adjusting the balance between a penalty to the learning cost concerning the first ROI size and a penalty to the learning cost concerning the second ROI size. For example, if the first ROI size is “large”, and the second ROI size is “small”, a greater importance can be placed on the classification performance of an object in an ROI of size “large” than the classification performance of an object in an ROI of size “small”. When the balancing parameter value is appropriately adjusted, the target model can be caused to perform object detection within such a range that does not increase the classification error for size “large” and with an appropriate classification error for size “small”.

The balancing parameter can similarly be controlled even for, for example, the class type of an object, the position of an ROI (in a case in which, for example, an object on the lower side or at the center of an image is important), and the balance between class classification and the position accuracy of an ROI. For example, the loss function according to Modification 10 can be designed as the sum of a learning cost of an object concerning a first ROI position and a learning cost of an object concerning a second ROI position. In this case, the learning costs are defined as an estimated error concerning class classification of a corresponding object and an error concerning an ROI size, respectively. As another example, the loss function according to Modification 10 can be designed as the sum of a learning cost of an object concerning a first class type and a learning cost of an object concerning a second class type. In this case, the learning costs are defined as an estimated error concerning class classification of a corresponding object and an error concerning an ROI size and/or an ROI position, respectively.

(Modification 11)

The target model and the reference model according to Modification 11 use neural networks configured to perform multitask training as neural networks having the same model architecture. The multitask training is a neural network capable of executing a plurality of tasks. The types of tasks to be combined are not particularly limited, and image classification, segmentation, object detection, depth estimation, and any other tasks may be combined. The balancing parameter according to Modification 11 adjusts a penalty to a learning cost concerning a plurality of tasks.

The loss function Lᵢ according to Modification 11 is a loss function concerning multitask training, as indicated by equation (9) below, and is designed as the sum of a learning cost LT1ᵢ concerning a first task and a learning cost LT2ᵢ concerning a second task. The learning costs LT1ᵢ and LT2ᵢ are designed in accordance with the task. For example, in a multitask of segmentation and depth estimation, a cross entropy for each pixel is used as a learning cost concerning segmentation, and a square error for each pixel or the like is used as a learning cost concerning depth estimation. Since the target model according to Modification 11 has one model architecture, the description of j is eliminated. The balancing parameter value a according to Modification 11 is a balancing parameter used to adjust the balance between a penalty to the learning cost LT1ᵢ and a penalty to the learning cost

LT2ᵢ. The balancing parameter value a according to the Modification 11 can take a value from 0 to 1.

Lᵢ=aLT1ᵢ+(1−a)LT2ᵢ (9)

The reference model according to Modification 11 is trained in accordance with the arbitrary balancing parameter value a. For example, in the reference model, a=1, and training with importance placed on the learning cost LT1ᵢ of the first task is performed. According to Modification 11, in the training process of the target model, the balancing parameter value is dynamically adjusted, thereby performing iterative learning while adjusting the balance between a penalty to the learning cost LT1ᵢ concerning the first task and a penalty to the learning cost LT2ᵢ concerning the second task. For example, if the first task is segmentation, and the second task is depth estimation, it is possible to easily implement adjustment for, for example, maximizing the estimation accuracy of depth estimation within the range in which the recognition ratio of segmentation has a desired accuracy or more. This makes it possible to generate a target model having inference performance desired by the operator.

(Modification 12)

The target model and the reference model according to Modification 12 are neural networks for a neural architecture search. The balancing parameter value a according to Modification 12 is a parameter used to adjust the balance between a penalty to a learning cost LE and a penalty to a calculation cost LC, which is included in a loss function concerning the neural architecture search, as indicated by equation (10) below. For Modification 12 as well, the description concerning j is eliminated.

L=aLE+(1−a)LC (10)

The reference model according to Modification 12 is trained in accordance with the arbitrary balancing parameter value a. For example, in the reference model, the balancing parameter value a is set to “1”, and training with importance placed on the learning cost LE is performed. According to Modification 12, in the training process of the target model, the balancing parameter value is dynamically adjusted, thereby performing iterative learning while adjusting the balance between a penalty to the learning cost LE and a penalty to the calculation cost LC. This makes it possible to, for example, generate a neural network that reduces the calculation cost while sacrificing inference performance to some extent as compared to the reference model. As described above, according to Modification 12, it is possible to search for a neural network having inference performance desired by the operator.

(Modification 13)

In the above-described embodiment, each of the target model and the reference model is a neural network as an example of a machine learning model. For the target model and the reference model according to reference model 13, a training method for sequentially executing optimization suffices, and an arbitrary machine learning model such as a support vector machine may be used.

(Modification 14)

The above-described embodiment and Modifications 1 to 13 can appropriately be combined as long as the balancing parameter value is changed in the training process of the target model.

### Other Embodiments

FIG. 11 is a block diagram showing an example of the hardware configuration of the learning apparatus 100 according to this embodiment. The learning apparatus 100 includes a processing circuit 11, a main storage device 12, an auxiliary storage device 13, a display device 14, an input device 15, and a communication device 16. The processing circuit 11, the main storage device 12, the auxiliary storage device 13, the display device 14, the input device 15, and the communication device 16 are connected via a bus.

The processing circuit 11 executes a training program read out from the auxiliary storage device 13 to the main storage device 12, and operates as the acquisition unit 1, the learning unit 2, and display control unit 3. The main storage device 12 is a memory such as a ROM (Read Only Memory) or a RAM (Random Access Memory). The auxiliary storage device 13 is an HDD (Hard Disk Drive), an SSD (Solid State Drive), a memory card, or the like.

The display device 14 displays various kinds of display information. The display device 14 is, for example, a display, a projector, or the like. The input device 15 is an interface configured to operate a computer. The input device 15 is, for example, a keyboard, a mouse, or the like. If the computer is a smart device such as a smartphone or a tablet terminal, the display device 14 and the input device 15 are, for example, a touch panel. The communication device 16 is an interface configured to communicate with another apparatus.

The program to be executed by the computer is recorded, as a file of an installable format or executable format, in a computer-readable storage medium such as a CD-ROM, a memory card, a CD-R, or a DVD (Digital Versatile Disc) and provided as a computer program product.

The program to be executed by the computer may be provided by storing the program on a computer connected to a network such as the Internet and downloading it via the network. Alternatively, the program to be executed by the computer may be provided via a network such as the Internet without downloading.

The program to be executed by the computer may be provided by building the program in a ROM or the like in advance. The program to be executed by the computer has a module configuration including, of the functional configuration (functional blocks) of the above-described learning apparatus 100, functional blocks executable by the program. As actual hardware, the processing circuit 11 reads out the program from a storage medium and executes it, thereby loading the functional blocks onto the main storage device 12. That is, the functional blocks are generated on the main storage device 12.

Some or all of the above-described functional blocks may be implemented not by software but by hardware such as an IC (Integrated Circuit). If the functions are implemented using a plurality of processors, each processor may implement one of the functions or may implement two or more of the functions.

The computer that implements the learning apparatus 100 can have an arbitrary operation mode. For example, the learning apparatus 100 may be implemented by one computer. Also, for example, the learning apparatus 100 may be operated as a cloud system on a network.

Hence, according to this embodiment, it is possible to efficiently obtain a machine learning model having a desired effect.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A learning apparatus comprising a processing circuit:
acquires first sequence data representing transition of inference performance according to a training progress of a first machine learning model trained in accordance with a first training parameter value concerning a specific training condition; and
performs iterative learning of a second machine learning model in accordance with a second training parameter value concerning the specific training condition and change the second training parameter value based on the inference performance of the second machine learning model and the first sequence data in a training process of the second machine learning model.

2. The apparatus according to claim 1, wherein the processing circuit
generates, based on the first sequence data and second sequence data representing the transition of the inference performance from a training start stage to a current progress stage of the second machine learning model, predicted sequence data representing the transition of the inference performance from the current progress stage to a training end stage of the second machine learning model, and
changes the second training parameter value in accordance with the predicted sequence data.

3. The apparatus according to claim 2, wherein the processing circuit changes the training parameter value in accordance with a difference between a recognition ratio represented by the predicted sequence data and an allowable value in a predetermined training stage.

4. The apparatus according to claim 2, processing circuit display a curve corresponding to the predicted sequence data, a curve corresponding to the first sequence data, a curve corresponding to the second sequence data, a curve corresponding to transition of a difference between the first sequence data and the second sequence data, a curve corresponding to transition of the training parameter value after correction by the learning unit, and/or the allowable value on a display.

5. The apparatus according to claim 2, wherein the processing circuit calculates the predicted sequence data by multiplying the second sequence data from the current progress stage to the training end stage by a ratio of the difference between the first sequence data and the second sequence data.

6. The apparatus according to claim 2, wherein the processing circuit changes the second training parameter value based on the difference between the inference performance represented by the predicted sequence data and the inference performance represented by the first sequence data in the training end stage and an allowable value for the difference.

7. The apparatus according to claim 1, wherein the processing circuit changes the second training parameter value in accordance with a difference between the inference performance represented by the first sequence data and the inference performance of the second machine learning model in a predetermined training progress stage, or a difference between the first sequence data and second sequence data representing transition of the inference performance according to the training progress of the second machine learning model.

8. The apparatus according to claim 7, wherein the processing circuit changes the second training parameter value based on the difference and an allowable value for the difference.

9. The apparatus according to claim 1, wherein the processing circuit changes the second training parameter value such that if the difference is larger than the allowable value for the difference, the second training parameter value becomes close to the first training parameter value, and if the difference is smaller than the allowable value, the second training parameter value is separated from the first training parameter value.

10. The apparatus according to claim 1, wherein if a difference between inference performance represented by the first sequence data and the inference performance of the second machine learning model is larger than a reference error, the processing circuit t redoes the iterative learning from the training progress stage to which the training has gone back.

11. The apparatus according to claim 1, wherein the specific training condition is a balancing parameter used to adjust a penalty to a learning cost included in a loss function.

12. The apparatus according to claim 11, wherein
the second machine learning model switchably has a plurality of model architectures corresponding to a plurality of calculation costs for processing the same task, respectively,
the first machine learning model has a specific model architecture corresponding to a specific calculation cost in the plurality of model architectures, and
the specific training condition is a balancing parameter value used to adjust a balance of penalties to a plurality of learning costs corresponding to the plurality of model architecture, respectively.

13. The apparatus according to claim 11, wherein the specific training condition is a balancing parameter value used to adjust a balance of penalties to the learning cost and a regularization term.

14. The apparatus according to claim 11, wherein the specific training condition is a balancing parameter value used to adjust a balance of penalties to a plurality of learning costs corresponding to a plurality of classes concerning one of segmentation and image classification.

15. The apparatus according to claim 11, wherein the specific training condition is a balancing parameter value used to adjust a balance of penalties to a plurality of learning costs corresponding to class classification or a ROI size concerning object detection.

16. The apparatus according to claim 11, wherein the specific training condition is a balancing parameter value used to adjust a balance of penalties to a learning cost of a first task and a learning cost of a second task concerning multitask training.

17. The apparatus according to claim 11, wherein the specific training condition is a balancing parameter value used to adjust a balance of penalties to a learning cost and a calculation cost concerning a neural architecture search.

18. A training method comprising:
acquiring first sequence data representing transition of inference performance according to a training progress of a first machine learning model trained in accordance with a first training parameter value concerning a specific training condition; and
performing iterative learning of a second machine learning model in accordance with a second training parameter value concerning the specific training condition and changing the second training parameter value based on the inference performance of the second machine learning model and the first sequence data in a training process of the second machine learning model.

19. A non-transitory computer readable storage medium including computer executable instructions, wherein the instructions, when executed by a processor, cause the processor to perform operations comprising:
acquiring first sequence data representing transition of inference performance according to a training progress of a first machine learning model trained in accordance with a first training parameter value concerning a specific training condition; and
performing iterative learning of a second machine learning model in accordance with a second training parameter value concerning the specific training condition and changing the second training parameter value based on the inference performance of the second machine learning model and the first sequence data in a training process of the second machine learning model.
